(19) United States
(12) Patent Application Publication
(10) Pub. No.: US 2008/0060740 A1
(43) Pub. Date: Mar. 13, 2008

(54) System and method for wetsuit assembly

(76) Inventors: Patrick F. O'Neill, Santa Cruz, CA (US); Randy Glenn Rainey, Chula Vista, CA (US)

Correspondence Address: MEHLIN DEAN MATTHEWS, P.O. BOX 24, SARATOGA, CA, 95071, US

(21) Appl. No.: 11/518,478

(22) Filed: Sep. 7, 2006

(51) Int. Cl. B32B 37/00

(52) U.S. Cl. 156/64; 156/378

(57) ABSTRACT

A system and method for producing a seam between adhesive coated edges of wetsuit panels. A clamping head assembly is mounted in a fixed position in relation to a work surface that supports wetsuit panels that are to be joined. The clamping head assembly includes a movable pair of jaws that are advanced in an open position toward the supported wetsuit panels to establish contact with the supported panels. After establishing contact, the jaws are closed to force the panel edges together. The jaws are then opened and retracted from the panels. The action of the jaws is governed by a controller such as a programmable logic controller (PLC). The controller may be used to control the operational cycle of the clamping head assembly by sensing the position of the mechanical elements of clamping head assembly.

### BACKGROUND OF THE INVENTION

1. Field of the Invention

The present invention relates to devices, systems, and methods useful for producing a seam between parts of a wetsuit.

2. Description of Related Art

Wetsuits are typically fabricated from a number of individual panels that are joined together at the edges by various methods. The most common methods for joining are stitching and gluing. The individual panels are usually a closed-cell foam material that may have one or both surfaces clad with a fabric.

Sewing machines have long been used for the joining of wetsuit panels by stitching; however, glued seams have typically been assembled by hand with the assistance of handheld tools. Efficient glued-seam assembly requires a considerable amount of skill on the part of the assembler since simultaneous handling of a tool, and the panels to be joined, is required.

The level of skill required for efficient conventional glued-seam assembly typically requires a significant amount of training time for an assembler. The skill level required of an operator and the training time required can limit the output of a wetsuit manufacturing operation.

Thus, a need exists for an improved system and method for glued seam assembly of wetsuits. There is also a need for system and method that simplifies the task of handling both a tool and the wetsuit panels being assembled.

### BRIEF SUMMARY OF THE INVENTION

The present invention provides a system for applying pressure to abutted wetsuit panels to produce a bonded seam. Further, the invention provides for hands-free operation of a tool that provides the pressure to the abutted wetsuit panels.

In one embodiment of the invention a clamping head assembly is mounted in a fixed position in relation to a work surface that supports wetsuit panels that are to be joined. The clamping head assembly includes a movable pair of jaws that are advanced in an open position toward the supported wetsuit panels to establish contact with supported panels. After establishing contact, the jaws are closed to force the panel edges together. The jaws are then opened and retracted from the panels. The jaws may be maintained in a closed position for a brief period (dwell time) prior to being opened.

In another embodiment the action of the clamping head assembly described above is initiated by a trigger sensor that detects a signal from an operator (e.g., closure of a foot switch). The signal may provide for a single cycle of operation with each signal occurrence, or may provide for continuous cycling as long as the signal is present.

In a further embodiment the action of the clamping head assembly described above is governed by a controller such as a programmable logic controller (PLC). The controller may be used to control the operational cycle of the clamping head assembly by sensing the position of the mechanical elements of clamping head assembly. The controller may also provide for timing of the jaw closure and/or the cycle rate.

### BRIEF DESCRIPTION OF THE DRAWINGS

FIG. 1 shows a block diagram of a wetsuit seam bonding system in accordance with an embodiment of the present invention.

FIG. 2 shows a perspective view of a wetsuit seam bonding station in accordance with an embodiment of the present invention.

FIG. 3A shows a side view of a dynamic jaw module in accordance with an embodiment of the present invention.

FIG. 3B shows a perspective view of a tilting jaw module in accordance with an embodiment of the present invention.

FIG. 4A shows a pivot jaw assembly in accordance with an embodiment of the present invention.

FIG. 4B shows a sliding jaw assembly in accordance with an embodiment of the present invention.

FIG. 5 shows a control flow diagram in accordance with an embodiment of the present invention.

FIG. 6 shows an operational flow diagram in accordance with an embodiment of the present invention.

### DETAILED DESCRIPTION OF THE INVENTION

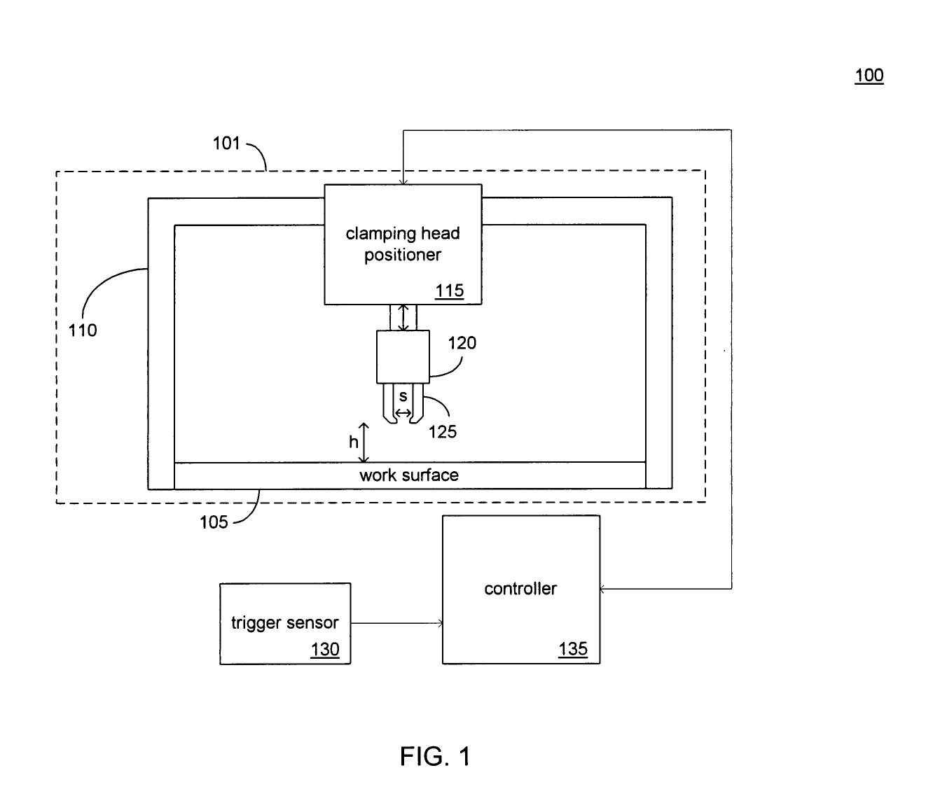

FIG. 1 shows a block diagram 100 of an embodiment of a wetsuit seam bonding system. A workstation 105 is coupled to a controller 135 and a trigger sensor 130. The workstation 100 includes a work surface 105 for supporting wetsuit panels that are to be joined. The work surface 105 is a substantially flat surface that preferably has a low coefficient of friction with respect to the wetsuit panels so that the panels may be manipulated with a minimum effort.

A clamping head positioner 115 is coupled to the work surface 105 by a support 110. It is preferable that the support 110 be a rigid structure that is capable of maintaining a fixed position for the clamping head positioner 115 with respect to the work surface 105 during operation. It is desirable to minimize oscillation or displacement of the clamping head positioner 115 during operation.

In an alternative embodiment, the clamping head positioner 115 and the work surface 105 are not directly coupled, but are otherwise restrained so that clamping head positioner 115 and work surface 105 maintain a fixed separation during operation. For example the work surface 105 and/or clamping head positioner 115 may supported by or mounted on a floor or wall.

The clamping head positioner 115 includes an actuator that provides vertical displacement to the clamping head 120. Examples of actuators that may be used are pneumatic cylinders and solenoids. The clamping head 120 includes a pair of jaws 125. The opening and closing of the jaws 125 may be synchronized with the vertical displacement of the clamping head 120.

The clamping head positioner 115 and the clamping head 120 are coupled to a controller 135. The controller 135 controls the timing of the vertical displacement of the clamping head 120 and may also control the timing of the opening and closing of the jaws 125.

For example, when a pneumatic cylinder is used as the actuator for providing vertical displacement of the clamping head 120, the controller may be used to control the gas flow to the pneumatic cylinder. On/off solenoid valves may be used, in which case the vertical displacement rate of the clamping head 120 may be adjusted by changing the working gas pressure. Alternatively, the vertical displacement rate of the clamping head 120 may be adjusted by using a proportional valve to meter gas from a constant pressure gas source.

Clamping head positioner 115 may include a sensor for determining the position of the clamping head 120 with respect to the clamping head positioner 115. For example a pneumatic cylinder with an integrated magnetic sensor may be used to provide the vertical displacement. Since the clamping head positioner 115 is essentially fixed with respect to the work surface 105, the displacement between the clamping head positioner 115 and the clamping head 120 may be used to determine the displacement between the jaws 125 and the work surface 105.

The clamping head 120 may include a light source for illuminating a portion of a workpiece to aid in the alignment of the workpiece with respect to the jaws 125. The light source may be a solid-state laser.

The maximum value for the vertical separation (h) between the jaws 125 and the work surface 105 is preferably a value that is sufficient to allow for the unhindered positioning of wetsuit panels or a partially assembled wetsuit beneath the jaws 125. The minimum value for the jaw separation (s) is that required to allow the jaws to provide sufficient compression to mated edges of wetsuit panels that are being bonded.

The separation (h) may be established through force limit or by displacement limit. The force limit may be established by a preset limit on the force used to drive the vertical displacement of the clamping head, or it may be determined by a feed back loop. When force feedback is used, the load against the jaws 125 is sensed and the downward vertical displacement of the jaws 125 is halted when the force between the jaws 125 and the wetsuit panels reaches a predetermined value. Force feedback allows the vertical separation (h) to vary from cycle to cycle, and is useful when the thickness of the material beneath the jaws 125 varies over a large range.

The vertical separation (h) may be established by using a mechanical stop to limit the vertical displacement of the clamping head 120. For example, a pneumatic cylinder may be cycled between its inherent limits. A displacement limited separation (h) is not easily modified on a per cycle basis, but may provide faster cycle times since a feedback loop is not required. The vertical separation (h) may be adjusted by changing the position of the clamping head positioner 115 with respect to the support 110.

The jaws 125 are typically maintained in an open position until the minimum vertical separation (h) is reached during a downstroke of the clamping head 120, or contact is established with the workpiece. When a displacement limit is used, closure of the jaws 125 is initiated after jaws 125 have reached the displacement limit. A short delay may be inserted between the arrival at the lowest position and the closure of the jaws to allow for damping of oscillations in the system.

Similar to the displacement of the clamping head 120, the closure of the jaws 125 may be force limited or displacement limited. The minimum jaw separation (s) may be determined by feedback from a force sensor, setting the maximum force used to close the jaws 125 or it may be determined by a mechanical stop. Once the jaws 125 are closed, a dwell time may be observed prior to opening of the jaws 125 and the retraction of the clamping head 120.

In one embodiment detection of an occurrence of signal by the trigger sensor 130 may be used to cause the controller 135 to initiate a single clamping cycle. In an alternative embodiment the controller 135 may repeat the clamping cycle as long as the signal is detected by the trigger sensor 130. Logically speaking, the operation may be either edge-triggered or level-triggered.

The trigger sensor 130 may be a foot switch, motion detector, optical scanner, acoustic recognition device, or other sensing device that is capable of interpreting an action on the part of the operator. An operator's voice or movement of an operator's head or eyes may be used as signal for the trigger sensor 130.

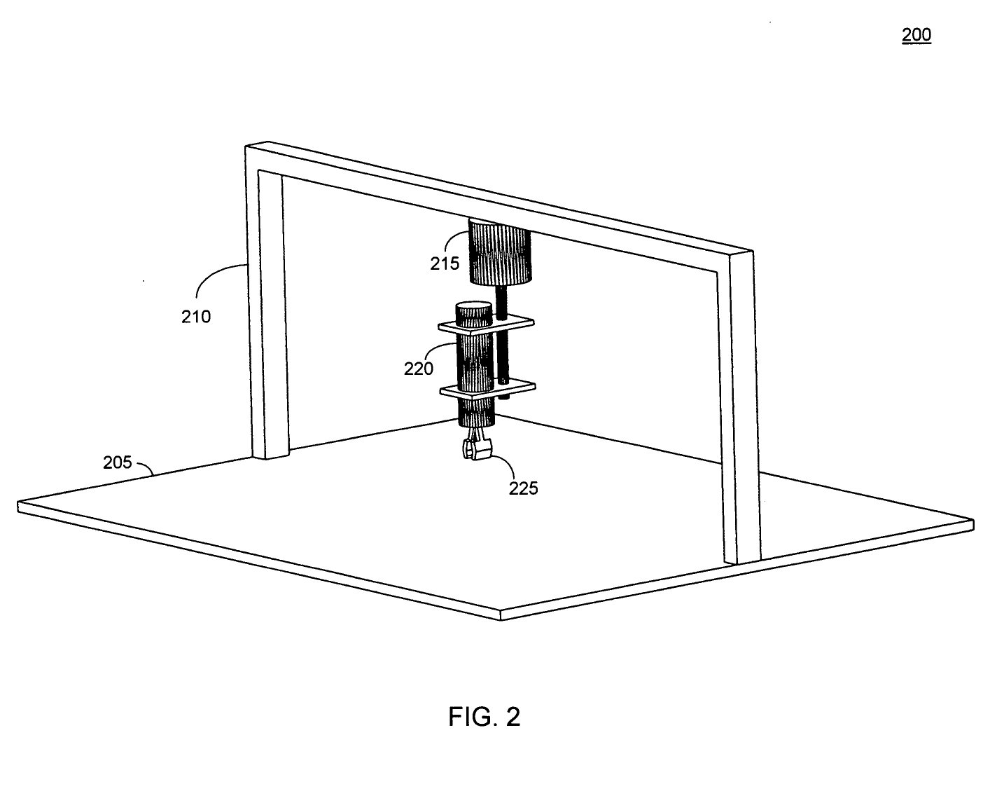

FIG. 2 shows a perspective view of an embodiment of a wetsuit seam bonding workstation 200 similar to the workstation 100 of FIG. 1. A work surface 205 is coupled to first pneumatic cylinder 215 by a support 210. The first pneumatic cylinder 215 provides for the vertical displacement of a second pneumatic cylinder 220 that serves to actuate a pair of jaws 225.

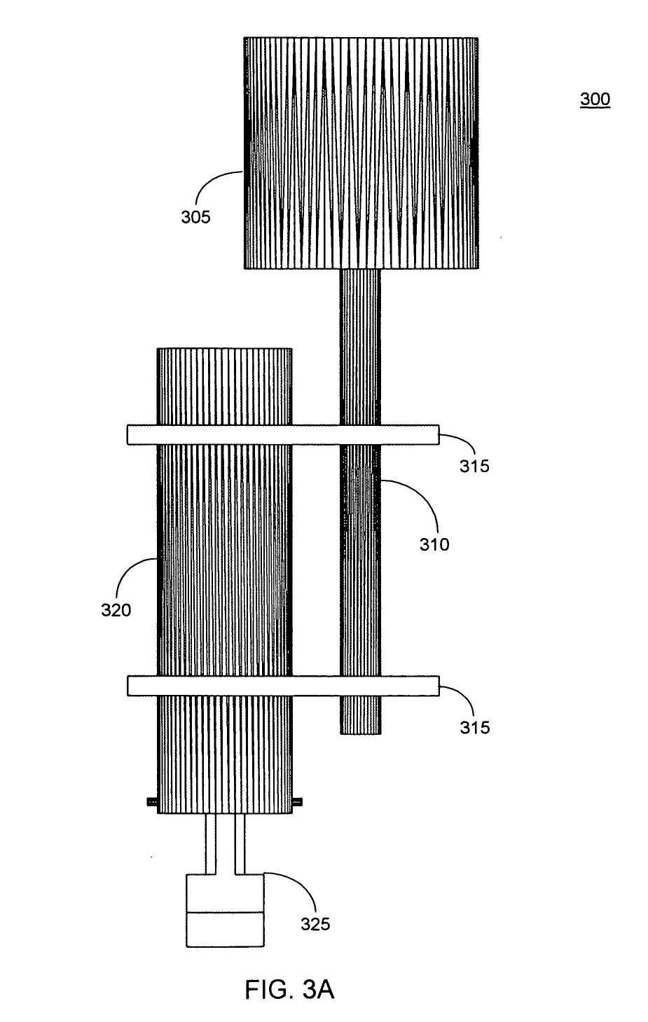

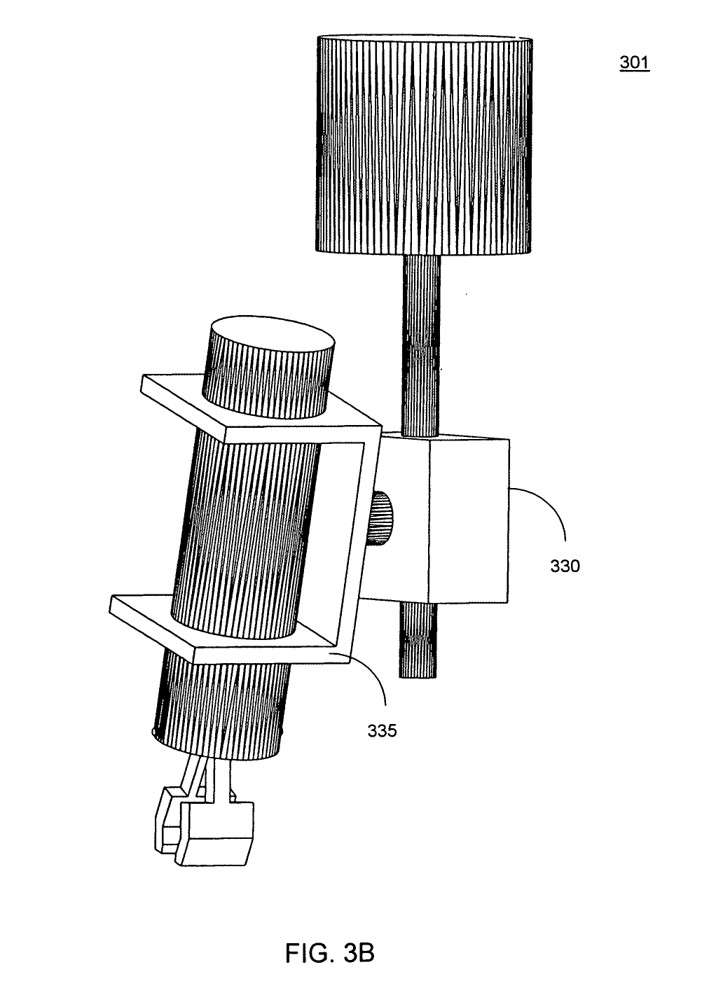

FIG. 3A shows a side view of a dynamic jaw module 300. A first double-acting air cylinder 305 is similar to the clamping head positioner 115 of FIG. 1 and is coupled to a second double-acting air cylinder 320 by brackets 315. Double-acting air cylinder 320 provides for the opening and closing of pair of jaws 325.

In order to maximize the operational speed and precision of the dynamic jaw module 300 it is desirable to minimize the mass of moving parts, particularly those parts that are subject to rapid acceleration. Double-acting air cylinders are preferable to single-acting air cylinders due to the absence of return spring resistance on the downstroke and a greater available force on the return stroke.

FIG. 3B shows a perspective view of a tilting jaw module 301 that is similar to the dynamic jaw module 300 of FIG. 3A. The tilting jaw module includes a rotary actuator 330 coupled to a rotating mount 335 that permit an operator to alter the vertical angle of the jaws with respect to the work surface. The vertical angle may be adjusted in response to a signal from the operator during assembly. For example, a wetsuit may have a seam between panels with unequal thickness, for which the vertical jaw angle may be adjusted.

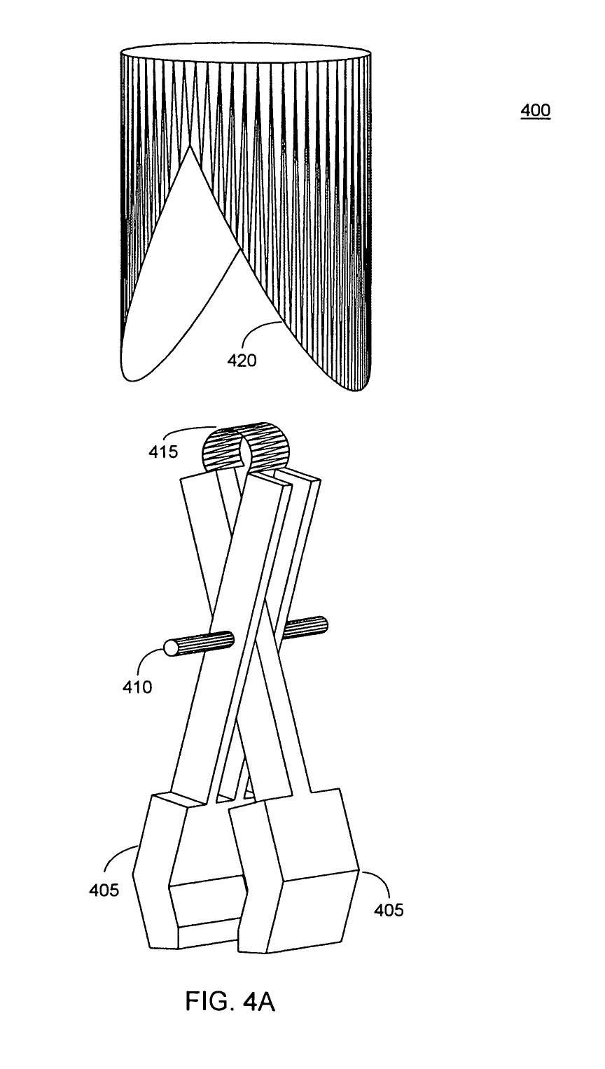

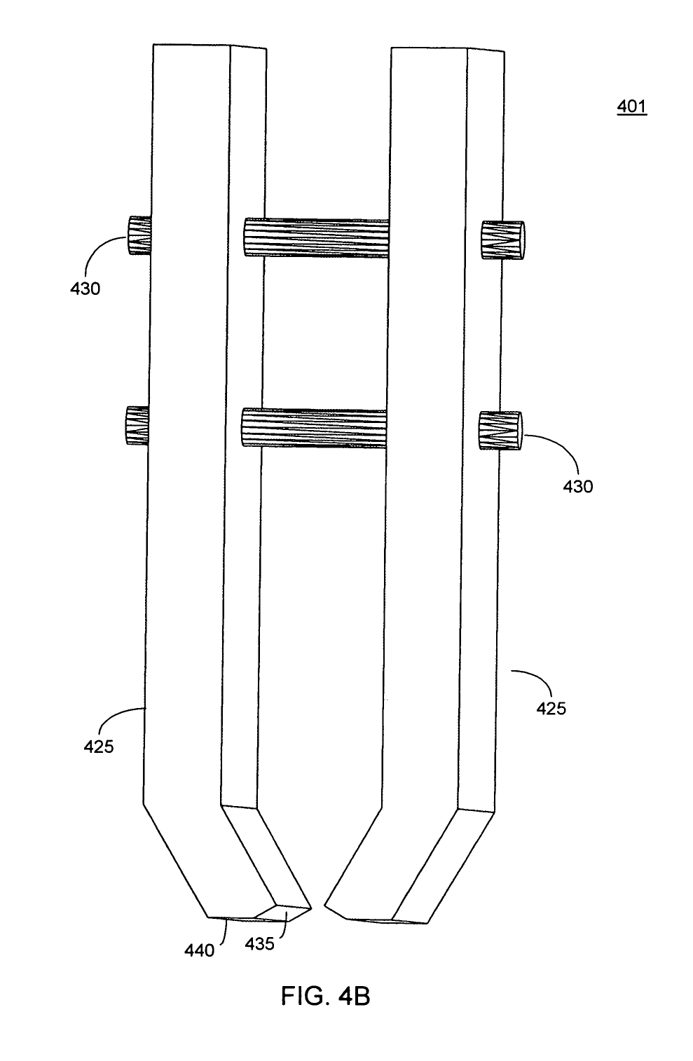

FIG. 4A shows an embodiment of a pivot jaw assembly 400. A pair of jaws 405 is mounted on a pivot shaft 410. A jaw-closing cylinder 420 has a wedge cutout that acts to close the jaws 405 when it engages the ends of the jaws 405. The jaw-closing cylinder 420 and pivot shaft may be incorporated in a pneumatic cylinder. A spring 415 acts to return the jaws to an open position when the jaw closing cylinder 420 is disengaged.

Since the tips of the jaws 405 travel in an arc, a long stroke or a thin panel may result in an unacceptably large force component normal to the work surface. The normal force component may be reduced by increasing the distance between the pivot shaft and the jaw tips.

FIG. 4B shows an embodiment of a sliding jaw assembly 401. A pair of jaws 425 is mounted on a pair of parallel shafts 430. The shafts 430 constrain the movement of the jaws 425 to a linear path that is parallel to the shafts 430. The sliding jaw assembly 401 may be used as an alternative to the pivot jaw assembly 400 of FIG. 4A to eliminate jaw motion normal to the work surface during jaw closure.

The jaws 425 have a relief 435 on the inner clamping surfaces. A finite amount of compression of the wetsuit panels is required to develop the friction that allows the jaws 425 to compress the mated panel edges together. Most of the compression is obtained at the heel 440, while the relief 435 reduces vertical compression of the panel edges that may degrade the seam. The relief 435 allows the jaws 425 to be operated closer to the seam with a shorter stroke.

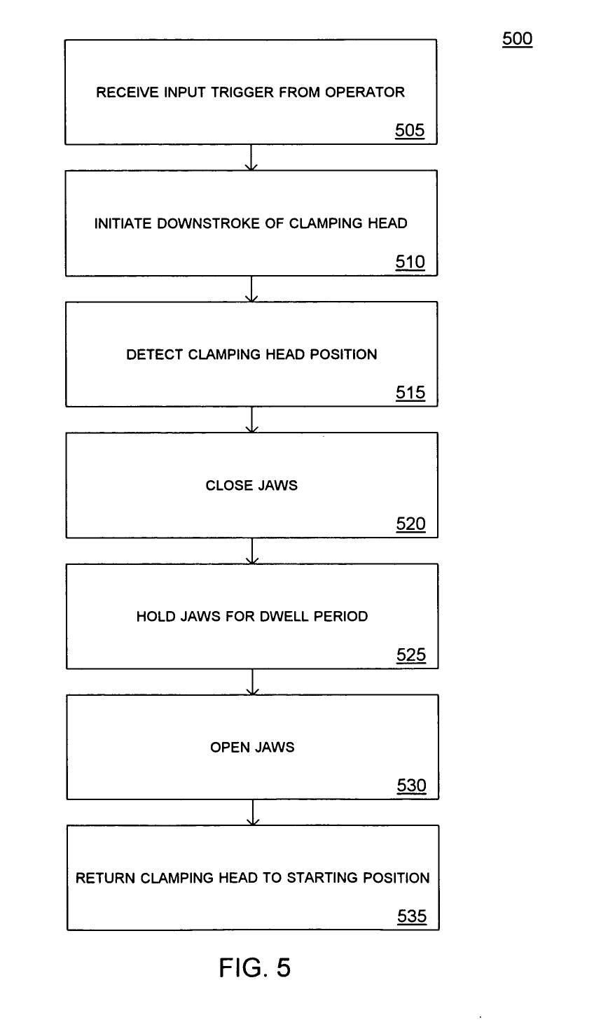

FIG. 5 shows a control flow diagram 501 for an embodiment of the controller 135 of FIG. 1. The flow diagram 501 includes a cycle of actions that may occur automatically after an appropriate signal is provided by an operator.

At step 505 a trigger signal from an operator is detected. The trigger signal may be conditioned by a sensor such as trigger sensor 130 of FIG. 1 and input to controller 135 as an electric current or voltage.

At step 510 a downstroke of the clamping head 120 is initiated. Initiation of the downstroke may be accomplished by operation of one or more pneumatic valves or the switching of one or more solenoid actuators.

At step 515 the clamping head position is detected. The clamping head position may be monitored continuously during the downstroke or the arrival at a specific position may be detected. The position being detected may be correlated with a reactive force produced by contact with a workpiece.

At step 520 the jaws 125 are closed. The closure of the jaws may be displacement limited or force limited. For systems in which the clamping head downstroke is accomplished at high speed, jaw closure may delayed by the controller after the detection of the clamping head position to allow a short period of time for damping of mechanical oscillations and relaxation of the workpiece that is being compressed.

At step 525 the jaws 125 are held in a closed position for a preset dwell time to allow intimate contact to be established between the mated edges of the wetsuit panels that are being bonded. A mechanical system will typically have an inherent delay; however, the inherent delay in a high-speed machine may be too short to allow for optimum bonding, thus a programmed dwell time may be used to enhance bonding.

At step 530 the jaws are opened and at step 535 the clamping head 120 is returned to its starting position. In contrast to the downstroke and jaw closure operations, it is preferred that steps 530 and 535 are performed without an intermediate delay. In order to provide optimum performance, it is desirable to minimize inherent delays in the system and insert programmed delays as necessary.

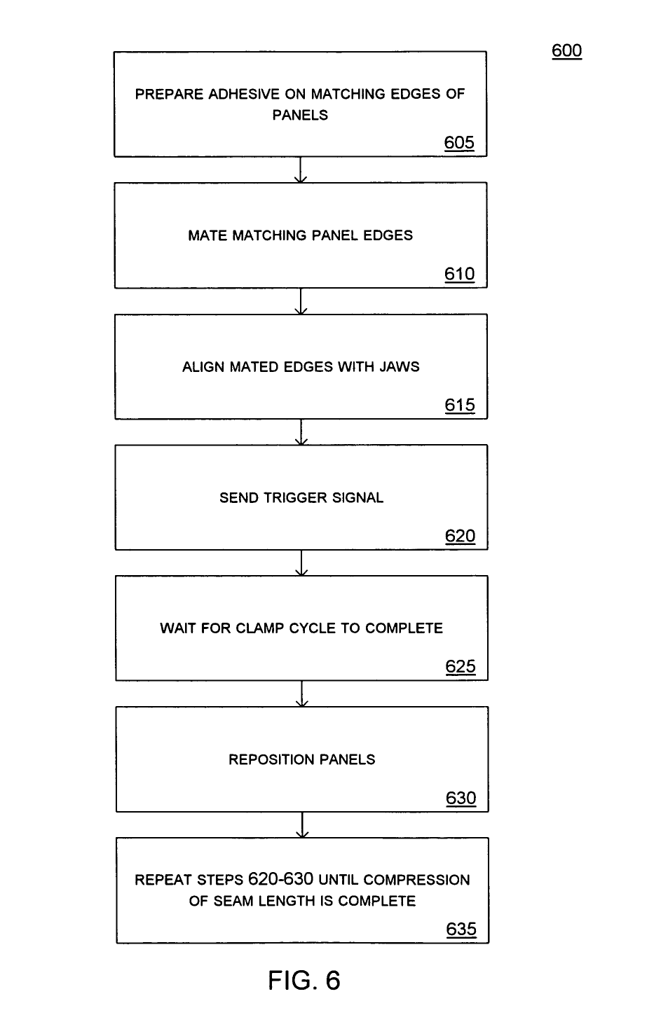

FIG. 6 shows a flow diagram 600 for use by an operator in conjunction with the system shown in FIG. 1. At step 605 adhesive is prepared on the edges of wetsuit panels to be joined. The adhesive may be prepared by application of adhesive to the edge or by reactivation of a previously applied adhesive (e.g., by the application of solvent).

At step 610 the prepared edges of the panels are aligned and brought into contact. At step 615 the mated panel edges are aligned between jaws 125 and the work surface 105. At step 620 a trigger signal is sent by the operator to initiate an automated clamp cycle similar to that shown in FIG. 5. At step 630 the panels are reposition with respect to the jaws 125.

At step 635 steps 620-630 are repeated until the length of the mated panel edges has been compressed by the jaws 125. It is to be understood that the repetition of step 620 may be either the transmission of a new signal (edge trigger) or the continuation of the initial signal (level trigger). Edge triggers and level triggers may be alternately used during the fabrication of a single wetsuit.

While the invention has been described in detail with reference to preferred embodiments thereof, it will be apparent to one skilled in the art that various changes can be made, and equivalents employed, without departing from the scope of the invention.

What is claimed:

1. A system for adhesive bonding of a wetsuit seam, said system comprising:
a work surface;
a clamping head comprising a set of jaws disposed above said work surface; and
a clamping head positioner coupled to said clamping head for changing the separation between said work surface and said clamping head.

2. The system of claim 1, wherein said work surface is rigidly coupled to said clamping head positioner.

3. The system of claim 1, wherein said clamping head positioner comprises a pneumatic actuator for changing the separation between said work surface and said clamping head.

4. The system of claim 1, further comprising a pneumatic actuator for closing said set of jaws.

5. The system of claim 1, further comprising a light source for illuminating a workpiece disposed on said work surface.

6. The system of claim 1, wherein said set of jaws is a pivot jaw assembly.

7. The system of claim 1, wherein said set of jaws is a sliding jaw assembly.

8. The system of claim 1, further comprising a controller for controlling the changing of the separation between said work surface and said clamping head.

9. The system of claim 8, wherein said controller is a programmable logic controller.

10. The system of claim 8, wherein said controller is coupled to a sensor for determining the presence of said clamping head at a particular position above said work surface.

11. The system of claim 8, wherein said controller is coupled to a trigger sensor for sensing a signal provided by an operator.

12. The system of claim 11, wherein said trigger sensor is a foot switch.

13. A method for semi-automated of bonding panel edges in a wetsuit using a set of jaws coupled to a controller, said method comprising:
preparing adhesive on said panel edges;
mating said panel edges;
aligning said panel edges with said set of jaws; and
transmitting a trigger signal to said controller to initiate a clamp cycle.

14. The method of claim 13, further comprising waiting for said clamp cycle to complete and repositioning said panel edges.

15. The method of claim 13 wherein said trigger signal is a level-trigger signal.

16. The method of claim 13 wherein said trigger signal is an edge-trigger signal.

17. A microprocessor controlled system for adhesive bonding of a wetsuit seam, wherein in response to a signal from an operator, said system performs a clamping cycle comprising:
initiating the movement of a clamping head towards a mated pair of wetsuit panels; and
closing a set of jaws coupled to said clamping head to provide compression between the mated edges of said mated pair of wetsuit panels.

18. The method of claim 17, wherein said clamping cycle further comprises opening said jaws and returning said clamping head to a starting position.

19. The method of claim 17, wherein said clamping cycle further comprises holding said jaws in a closed position for a dwell period.

20. The method of claim 17, wherein said clamping cycle further comprises detecting a position of said clamping head.
